(19) United States
(12) Patent Application Publication
(10) Pub. No.: US 2002/0018477 A1
(43) Pub. Date: Feb. 14, 2002

(54) Bandwidth and path allocation method for a switched fabric connecting multiple multimedia buses

(75) Inventor: Abraham Yehuda Katz, Karmiel (IL)

Correspondence Address: BROWDY AND NEIMARK, P.L.L.C., 624 NINTH STREET, NW, SUITE 300, WASHINGTON, DC, 20001-5303, US

(73) Assignee: FireMedia Communications (Israel) Ltd., Yokneam (IL)

(21) Appl. No.: 09/858,867

(22) Filed: May 17, 2001

Related U.S. Application Data
(60) Provisional application No. 60/205,091, filed on May 18, 2000.

(51) Int. Cl. H04L 12/56; H04J 3/22

(52) U.S. Cl. 370/401; 370/468

(57) ABSTRACT

A method for allocating bandwidth and routing paths for isochronous packets of a data stream in a network of buses including a source bus and one or more remote destination buses interconnected by a switching fabric is described and implemented in a data network. A network management node is assigned from an available network node and weight is allocated to each channel input output, CIO, based on existing path allocations. For a new request, bandwidth allocation for the isochronous packets in the source bus is obtained and the network management node negotiates bandwidth and routing path allocation for the isochronous packets in the switching fabric and remote destination buses. The network management node obtains bandwidth allocation for the isochronous packets on the remote destination bus and selects the optimal routing path in the switching fabric in dependence on the bandwidth requirements of the data stream and assigned weights. A channel number for the stream is then assigned and used for routing purposes.

### FIELD OF THE INVENTION

The present invention relates to a bandwidth and path allocation method and system for use with digital packet networks, and is particularly applicable to multimedia networks supporting the lossless transfer of audio and video streams, in a timely manner.

### BACKGROUND TO THE INVENTION

In data communication networks, data packets are transmitted from a source node to a receiver node. Upon receipt, packets are checked for correctness and than acknowledged. In the event of an error, packets are retransmitted resulting with an unordered packet stream. The receiving node reorders and assembles the packets to reconstitute the original data. In traditional data communication networks, the emphasis has been to ensure that the complete data stream is eventually received at the receiver node. Whilst the timing and receipt order of packets is not seen as critical, obviously the faster and more ordered the received series of packets is, the better. Switching fabrics for traditional networks such as Ethernet and ATM are well known in the art. Recently, additions to these traditional switching fabrics permit quality of service to be supported, thereby achieving a guaranteed average rate of transmission of packets.

However, in the case of multimedia data streams, the ordering and timing of constituent packets in a received data stream is critical. Therefore, there is demand for stream transport and corresponding switching fabrics that are able to guarantee transfer of packets in a timely manner, (normally a guaranteed packet transfer each clock cycle). For example, the requirements may be that a packet transfer is guaranteed to occur every 125 micro seconds. There may be a further requirement for low latency between source and receipt nodes. For high quality multimedia traffic, clocks within all nodes within the data network may need to be synchronised (ie. have the same frequency).

Current switching systems and corresponding algorithms do not guarantee packet transfer at all, nor do they guarantee packet transfer in a timely manner. Therefore, large buffers must be used in combination with deliberately introduced latency to achieve high quality video streaming. The buffers and latency are used to give a receiving node the ability to control packet time jitter. Clock synchronisation is rarely supported and synchronizing the clocks on each node is an extremely complicated task.

There exist multimedia buses designed to support asynchronous and isochronous protocols. Such buses typically have an arbitration scheme to support the two protocols. The buses guarantee isochronous packet transfer by managing both bandwidth and resources. As the bus is completely in control of the communications medium (itself), guaranteed timely packet delivery is possible. However, hardware limitations means that buses can only support short distance connections and the number of connected devices along a bus is limited. Furthermore, in contrast to a network, a bus can only allow one source to transmit data at any one time.

There is thus a widely recognized need for, and it would be highly advantageous to have a method of allocating bandwidth and switching path to data packets in a switched fabric in such a manner that isochronous data packets can be delivered in a timely manner. It is further advantageous and there is a corresponding recognized need to provide a data communication network implementing the aforementioned method.

### STATEMENT OF INVENTION

According to a first aspect of the present invention, there is provided a method for allocating bandwidth and routing paths for isochronous packets of data streams in a network of buses interconnected by a switching fabric, comprising:

a) assigning a weight to each channel input output, CIO, based on existing path allocations;

b) selecting the optimal routing path for each data stream in dependence on the bandwidth requirements of the data stream and assigned weights;

c) assigning a channel number for each stream; and,

d) updating routing tables in the selected optimal path for the channel number to enable the data stream flow along the path.

The method and corresponding communication network in the present invention provide optimal multimedia data routing through a network composed of buses and switched fabric. In particular, several multimedia buses can be bridged and connected together with priority given to isochronous packets over asynchronous packets. The method and network of the present invention support a number of features including:

a) asynchronous and isochronous data streams;

b) avoidance of data transfer blockages during operation;

c) guaranteed data packet delivery with no packet losses;

d) guaranteed isochronous packet delivery in a timely manner;

e) no data congestion within switching fabric;

f) automatic system configuration;

g) frequency synchronisation across all fabric and buses;

h) variable frame size up to 2 Kbytes;

i) assignment of a channel number to isochronous streams and optimal computation of channel route;

i) routing of isochronous streams by channel number instead of destination address; and,

k) support of multicast, unicast and broadcast of data.

A node only transfers an isochronous data stream over a bus once a channel and bandwidth has been allocated. An isochronous resource manager node manages bus resources so transmission is guaranteed, However, if a node needs to forward a stream to a remote bus, a switch fabric path with guaranteed bandwidth and priority must be obtained. A network manager is selected from available switching nodes during network initialisation with a task to allocate resources over the switched network, so that the stream packets arrive at their destination(s) in a timely manner.

In the event of a remote isochronous stream request between a number of buses, the bandwidth and channel availability checks must be made on the transmitting bas, the receiving bus and the switch fabric before granting. The transmitting bus portal communicates with the network manager which in turn negotiates with a destination bus portal selected based on the destination of the isochronous stream. The destination bus portal will become the isochronous channel source on the destination bus and therefore needs to negotiate with the IRM node of that bus (if the portal is not the IRM) to obtain the necessary channel and bandwidth. The network manager also determines and allocates the network fabric path (optimal path) and updates all switches routing tables within the network for this path.

In summary, for a remote bus stream request to be granted, the following are required:

1. grant of stream request on originating bus,

2. grant of stream request on destination bus,

3. grant of network fabric path.

In order to accomplish these requirements, a slightly modified shortest path algorithm is used.

The method may, further comprise:

ai) defining a channel isochronous load, ISL, for each CIO, the ISL comprising a predetermined maximum percentage of channel capacity; and

aii) making available the remainder channel capacity to asynchronous communication.

The step of selecting the optimal routing path may comprise rejection of paths that include a CIO whose weight incremented by the bandwidth requirements of the stream exceeds the CIO's ISL.

According to a second aspect of the present invention, there is provided a method for allocating bandwidth and routing paths for isochronous packets of a data stream in a network of buses including a source bus and one or more remote destination buses interconnected by a switching fabric, comprising:

i) assigning a network management node in the network on initialisation;

ii) assigning a weight to each channel input output, CIO, based on existing path allocations;

iii) obtaining bandwidth allocation for the isochronous packets in the source bus;

iv) requesting bandwidth and routing path allocation from the network management node for the isochronous packets to the remote destination buses, the network management node:

a) obtaining bandwidth allocation for the isochronous packets on the remote destination bus and selecting the optimal routing path in the switching fabric in dependence on the bandwidth requirements of the data stream and assigned weights;

b) assigning a channel number for the stream; and,

c) updating routing tables in the switching fabric of the selected optimal path for with routing commands indexed by the channel number to enable the data stream flow along the path.

The method may further comprise:

ia) defining a channel isochronous load, ISL, for each CIO, the ISL comprising a predetermined maximum percentage of channel capacity; and

iia) making available the remainder channel capacity to asynchronous communication.

The step of selecting the optimal routing path may comprise rejection of pats that include a CIO whose weight incremented by the bandwidth requirements of the stream exceeds the CIO's ISL.

The bandwidth requirements of a stream may comprise:

$$\frac{( \text{Requested data size} \times 4 )}{\text{Transmission speed index between source and destination}}$$

The transmission speed index between source and destination may take the values 1 representing speed of 100 Mbits/sec, 2 representing speed of 200 Mbits/sec, and 4 representing speed of 400 Mbits/sec.

The weight of a CIO may comprise the sum of the bandwidth requirements of isochronous data streams currently allocated to use the CIO.

The method may further comprise:

v) if all paths to all remote destination buses are rejected determining if data stream transmission at the source is required and deallocating the allocation at the source bus if it is not required.

The method may further comprise:

vi) incrementing the weight of each CIO in the paths allocated to the data stream by the data stream's bandwidth requirements.

According to a third aspect of the present invention, there is provided a computer readable medium, on which is stored a computer program of instructions for controlling a general purpose computer to for allocate bandwidth and routing paths for isochronous packets of data streams in a network of buses interconnected by a switching fabric, comprising, in combination:

means for assigning a weight to each channel input output, CIO, based on existing path allocations;

means for selecting the optimal routing path for each data stream in dependence on the bandwidth requirements of the data stream and assigned weights;

means for assigning a channel number for each stream; and,

means for updating routing tables in the selected optimal path for the channel number to enable the data stream flow along the path.

The computer readable medium may further comprise:

means for defining a channel isochronous load, ISL, for each CIO, the ISL comprising a predetermined maximum percentage of channel capacity; and

means for making available the remainder channel, capacity to asynchronous communication.

The means for selecting the optimal routing path may includes mean for rejecting paths that include a CIO whose weight incremented by the bandwidth requirements of the stream exceeds the CIO's ISL.

According to another aspect of the present inventions there is provided a computer readable medium, on which is stored a computer program of instructions for controlling a general purpose computer to for allocate bandwidth and routing paths for isochronous packets of data streams in a network of buses interconnected by a switching fabric, comprising, in combination:

means for assigning a network management node in the network on initialisation;

means for assigning a weight to each channel input output, CIO, based on existing path allocations;

means for obtaining bandwidth allocation for the isochronous packets in the source bus;

means for requesting bandwidth and routing path allocation from the network management node for the isochronous packets to the remote destination buses, the network management node including, in combination:

means for obtaining bandwidth allocation for the isochronous packets on the remote destination bus and selecting the optimal routing path in the switching fabric in dependence on the bandwidth requirements of the data stream and assigned weights;

means for assigning a channel number for the stream; and,

means for updating routing tables in the switching fabric of the selected optimal for path for with routing commands indexed by the channel number to enable the data stream flow along the path.

The computer readable medium according may further comprise means for determining the bandwidth requirements of a stream by executing the formula:

$$\frac{( \text{Requested data size} \times 4 )}{\text{Transmission speed index between source and destination}}$$

The computer readable medium may further comprise means for calculating the weight of a CIO from the sum of the bandwidth requirements of isochronous data streams currently allocated to use the CIO.

The computer readable medium may further comprise means for determining if all paths to all remote destination buses are rejected, means for determining if data stream transmission at the source is required and means for deallocating the allocation at the source bus if it is not required.

The computer readable medium may further comprise means for incrementing the weight of each CIO in the paths allocated to the data stream by the data stream's bandwidth requirements.

According to a further aspect of the present invention, there is provided a data communication network arranged for optimal allocation of bandwidth and routing paths for isochronous packets of a data stream, the network comprising:

a plurality of buses including a source bus and one or more remote destination buses, each bus having an isochronous resource manager responsible for bandwidth allocation to isochronous streams on it respective bus;

a switching fabric interconnecting the plurality of buses; and,

a network management node;

wherein each channel input output, CIO, in the network has an assigned weight value based on existing path allocations, and wherein upon receiving a request for bandwidth allocation for isochronous packets from a source on its own bus, the source bus being arranged to reserve bandwidth in its bus and requesting bandwidth and routing path allocation from the network management node for the isochronous packets to the remote destination buses, the network management node communicating with the isochronous resource manager of each destination bus to obtain bandwidth allocation for the isochronous packets on the remote destination bus, selecting the optimal routing path in the switching fabric in dependence on the bandwidth requirements of the data stream and assigned weights, assigning a channel number for the stream, and updating routing tables in one or more memories throughout the switching fabric of the selected optimal path for with routing commands indexed by the channel number to enable the data stream flow along the path.

### BRIEF DESCRIPTION OF THE DRAWINGS

An example of the present invention is now described in detail, with reference to the accompanying drawings in which:

FIG. 1A is an example of a multimedia switch fabric for use in the present invention;

FIG. 1B is a coding table used in routing tables of switches and portals;

FIG. 2 is a graph data representation of a switching fabric used to illustrate operation of the present invention;

FIG. 3 is a flow chart of an IEEE-1394 bus isochronous allocation process according to the present invention; and,

FIG. 4A is a flow chart of an isochronous stream network allocation process according to the present invention.

FIG. 4B is the continuation and the lower visual part of a flow chart of an isochronous stream network allocation process according to the present invention.

### DETAILED DESCRIPTION

In the present invention, a switched fabric connects several multimedia buses such as IEEE-1394 buses. The following describes a method for determining an optimal route for stream requests and management of the fabric bandwidth in an optimal way in accordance with the present invention. Allocation of each stream channel (for example, audio and video data stream signals) is performed via a negotiation process.

Throughout the following description a number of technical terms are used, the meanings of which are known to the skilled reader but provided below for reasons of clarity:

SWITCH—electronic circuitry capable of directing received data to none, a selection or all of its outputs.

CIO—channel input output, also known as a point to point connection. A connection between two switches or between a switch and a portal.

UNICAST—a data communication between a single source and a single destination.

MULTICAST—a data communication between a single source and multiple destinations.

BROADCAST—a data communication between a single source and all destinations.

ISOCHRONOUS PACKET—a packet routed by channel number. Isochronous packets are transmitted at a predetermined clock frequent. In each time cycles one packet has to be delivered.

ISL—isochronous load. This is the percentage of time in which a communications medium is allowed to carry isochronous data.

ASYNCHRONOUS PACKET—a packet routed by destination address. Asynchronous packet delivery is given lower priority than isochronous packet delivery. Delivery timing of asynchronous packets is not frequency limited and is frequently on a best effort basis.

PRIMARY PACKET—a packet that is originated in a multimedia bus. Allowable packet types are: asynchronous request packet, asynchronous response packet and isochronous packet.

REQ_DATA_UNITS—the number of bytes in a primary packet normalised by the speed between source and destination.

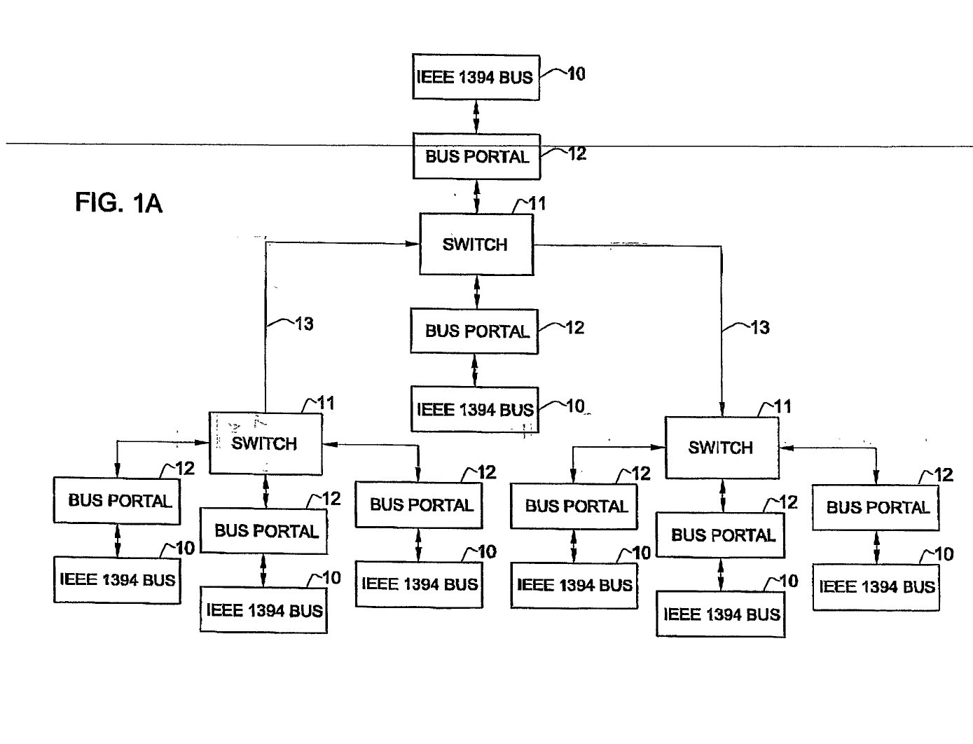

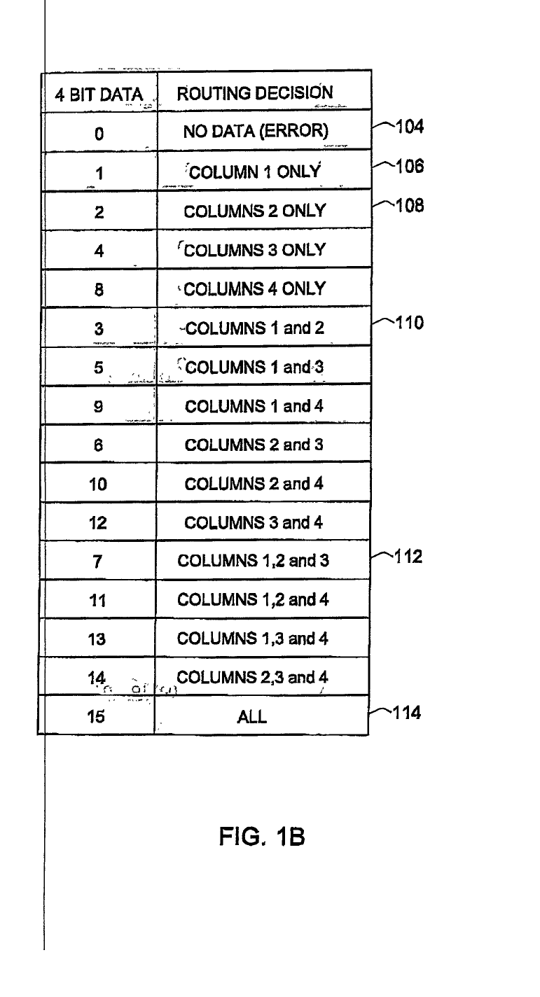

FIG. 1A is a schematic diagram of a possible switch fabric for use in the present invention. However, switch fabrics can be as large as required and any connection structure is permitted. A number of switches 11 are connected together. The switch fabric connects uses 10 via IEEE-1394 bus portal devices 12. Both IEEE-1394 buses 10 and bus portals 12 are well known to the skilled reader. A channel input output 13 (CIO) is the physical connection between a switch 11 and a bus portal device 12 or between two switches 11. A channel can carry data and control data movement in both directions (full duplex). A channel may be constructed from one or more of data carrier media, such as:

1. fibre optic cables.

2. coaxial cables.

3. UTP unshielded twisted pair or STP (shielded twisted pair) cables.

4. Wireless connection (such as electromagnetic radiation).

In the event of any fabric topology change or during power up, the switching fabric is reinitialised. The initialisation process includes:

1. selection of a network manager from one of the available switching devices in the network.

2. collection of network topology data by the network manager.

3. initialisation of routing tables.

Before forwarding a packet to the switching fabric, a portal encapsulates the packet with a header quadlet (32-byte computer word) and a trailer quadlet. The header quadlet includes the following fabric related information: packet size, routing address, packet type and request response negotiation field. The trailer quadlet is used for error detection.

Each switch 11 has a routing table. In the present example the switches 11 are 4 port switches. When a packet is received by a switch 11, a decision is made by the switch as to the output port or ports the packet should be written to. The decision is made by cross referencing the routing table with the packet header's routing address and the packet's type. In this particular example, the table is an array of 1024 bytes. The four most significant bits are used for asynchronous routing and the four least significant bits are used for isochronous routing.

An entry in the routing table for an asynchronous packet is indexed by destination bus address and only one output port is marked for each entry (asynchronous packets are routed only by unicast). The network manager node programs the asynchronous routing tables during the initalisation process. Such programming is well known in the art. For isochronous routing, the network manager programs an entry corresponding to the allocated stream path in the table during the stream allocation process. Upon receiving a request for a remote isochronous channel, the network manager processes the request and, if the request is granted, the network manager issues a fabric channel number to the requested stream. The channel number is used as the index to the entry in each routing table that stores the routing command for the stream. The network manager updates all switches 11 and bus portals 12 that are part of the allocated stream path with the routing information by placing appropriate entries in their routing tables. After the allocation process terminates an automatic packet flow is enabled to ensure the packet transmission is possible in a timely manner without intervention of the network manager node.

FIG. 1B illustrates part of a routing table using the 4 bit coding. The routing table is based on the above specific embodiment for a switch having four input ports and four output ports. Each bit of the four bit data routing word is set if the packet needs to be forwarded to the corresponding output port, thereby defining the packet routing within the switch. By way of example, in line 104, the value of the routing word is 0 and thus no routing is possible from this entry. In line 106, the value of the routing word is 1 (0001 in binary) and the routing destination is therefore to output port 1 only. In line 108, the value of the routing word is 2 (0010 in binary) and the routing destination is therefore to output 2 only. Line 110 has routing word value 3 (0011 in binary) and the routing destination is therefore to output ports 1 and 2. Whilst lines 112 and 114 have routing word values of 7 and 15 respectively (0111 and 1111 in binary respectively) and therefore gives routing destinations of output ports 1, 2 and 3 or all output ports respectively.

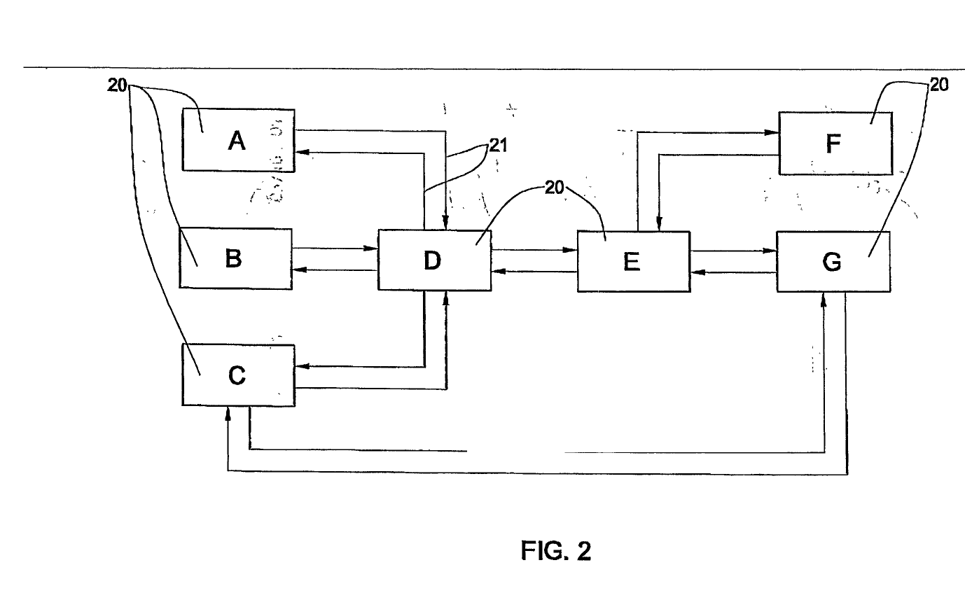

FIG. 2 is a graph data representation of a switching fabric used to illustrate operation of the present invention. Vertices 20 of the graph may be a switch or a bus portal. Links 21 connect the vertices 20 together. Each link represents an undirectional flow from source to destination (vertex to vertex). For a full duplex connection, two connections are shown, one for each direction. Each link 21 has an associated edge weight. The edge weight corresponds to the accumulated isochronous data units (defined below) assigned to the particular link 21. If, during the process of allocating a remote isochronous stream, the network manager decides to transmit a packet from vertex A to vertex D, and that path is granted, the weight of the link 21 between A and D is increased by the amount of the REQ_DATA_UNITS allocated for this stream. During de-allocation of a stream, the link weight decreases by the stream's REQ_DATA_UNITS.

If, for example, the packet is to be transmitted from vertex A to vertex G, available paths are from A to D to E and then to G or from A to D to C and then to G. Summing all edge weights used in the path gives the path cost. By finding all possible paths and their associated path costs, the shortest path algorithm allows us to select the path with minimum cost. Although the shortest path algorithm is known in the art, it is modified in the present invention so that edge weights are bounded. In this manner, if allocating a path will cause one of the edges to exceed a predetermined boundary value, that particular path is dropped from possible paths available. In the event that no path is found by the network manager, the request is denied.

Isochronous load (ISL) is defined above as the percentage of time in which a communications medium is allowed to carry isochronous data. For example, if ISL is 60 percent, the isochronous data carried by any particular link 21 cannot exceed 60 percent of available transmission time. In other words, 40 percent of the links resources are guaranteed to asynchronous communication. The ISL is only a maximum limit and asynchronous packets can utilise whatever channel bandwidth isochronous data streams are not currently using. Weight values associated with links are preferably stored at the network management node.

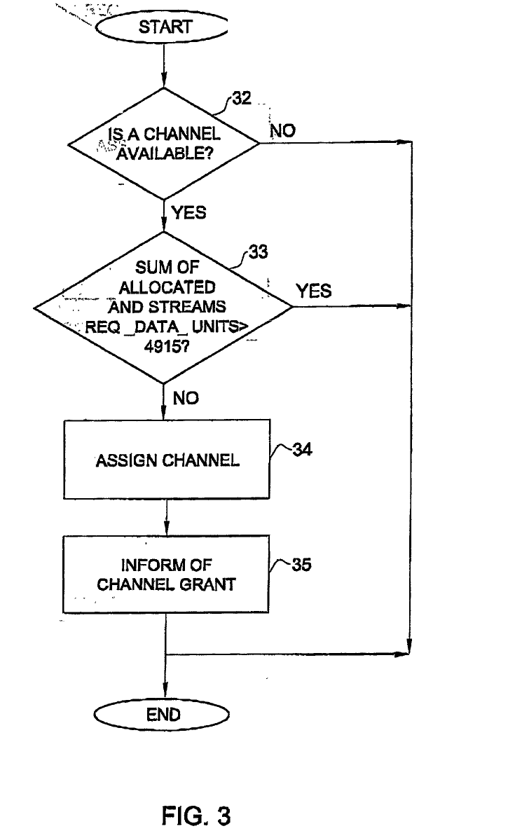

FIG. 3 is a flow chart illustrating isochronous data stream allocation on an IEEE-1394 bus according to the present invention. In this particular example, REQ_DATA_UNITS is defined as:

$$\frac{( \text{Requested data size} \times 4 )}{\text{Transmission speed index between source and destination}}$$

where: transmission speed between source and destination in this particular example takes the value: 1 for 100 Mbytes/sec; 2 for 200 Mbytes/sec; and 4 for 400 Mbytes/sec.

The total number of isochronous channels allowable over an IEEE-1394 bus is limited to 64. In step 32, if it is determined that there are less than 64 channels allocated, the algorithm proceeds to step 33 to determine whether there is bandwidth available. To determine this, the current REQ_DATA_UNITS is added to the total units already allocated and if this is less then 4915, the request is granted and assigned a channel in steps 34 and 35. The comparison of data units allocated being less than 4915 ensures that isochronous allocation does no exceed 80 percent of the available bus bandwidth, in order to enable asynchronous communication in the remaining 20%.

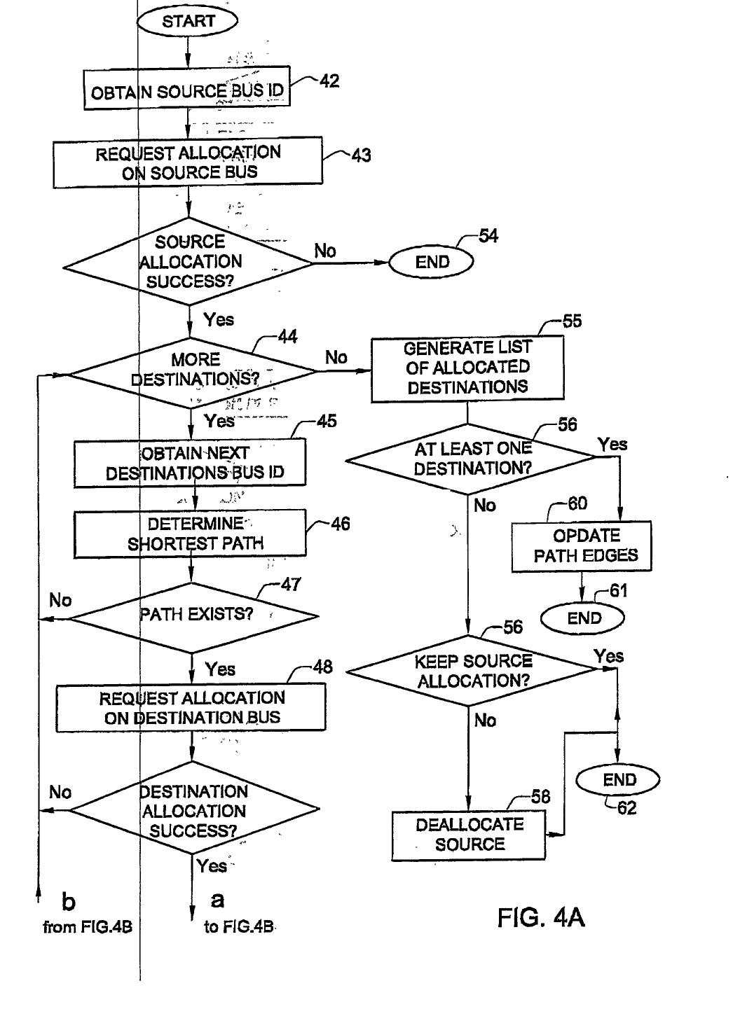

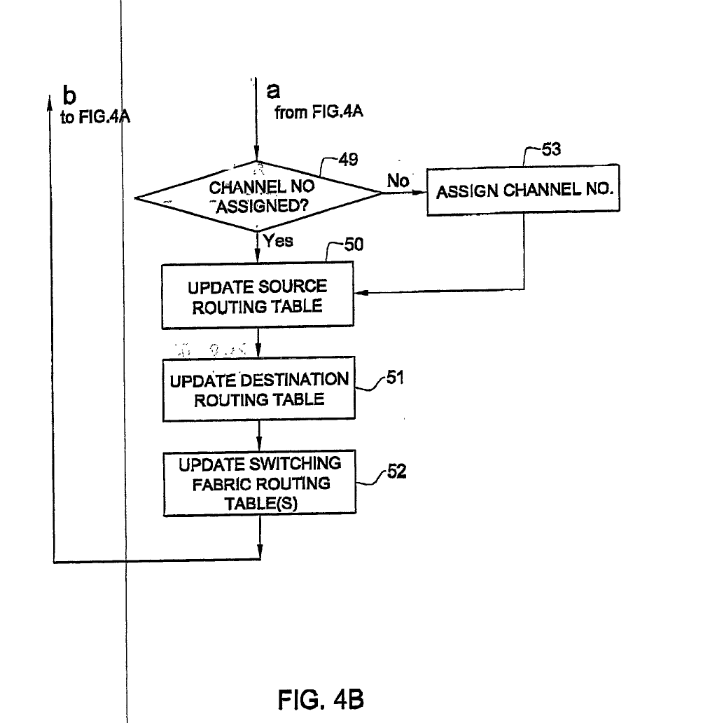

FIGS. 4A and 4B are the two parts of a unified flow chart illustrating isochronous stream allocation in a network according to the present invention. An isochronous source requesting a network channel will have one or more destination buses. For a stream to be transmitted from a source bus to a destination bus, an isochronous stream allocation must be made in the source bus, the destination bus and the network fabric. The allocated channel number is the same irrespective of whether there is a single destination or a number of destinations because the switching fabric supports multicasting and broadcast. The stream allocation process may grant stream connections to all requested destinations, none of the requested destinations or one or more of the requested destinations.

The allocation algorithm attempts to determine the best route for a stream request in dependence on the status of the network. Once a stream request is granted and a channel allocated, the channel allocation remains until the request is de-allocated. It is possible to have two isochronous streams with the same source bus and the same destination bus but which have different channel paths over the switching fabric.

In step 43, a stream allocation request for the source bus is made according to the algorithm of FIG. 3. If the request cannot be granted for the source bus, the overall request is rejected in step 54. If the request can be granted for the source bus, a stream request in the switching fabric and on the destination bus is obtained in turn for each destination bus in steps 44 to 53 to obtain stream allocations in each destination bus. In step 46, the shortest path in the switching fabric given edge weights and weight limitations (ISL) is determined as discussed above with reference to FIG. 2. If no path exists, this destination is marked as unreachable and the loop begins again at step 44. If a path exits, stream allocation is attempted for the destination bus according to the algorithm of FIG. 3 in step 48. If stream allocation at the destination bus fails, the destination is also marked as unreachable and the loop begins again at step 44. If the destination bus allocation is successful, a channel number is allocated in step 49 and 53 if this is the first successful destination request and routing tables throughout the switching fabric are updated for the stream to the destination in steps 50, 51 and 52. Once all destinations have been processed, a list of successful destination requests is generated in step 55. If a path is not possible to any of the requested destinations, it is determined in step 57 whether local source bus transmission is required. If there is such a requirement, the source bus allocation is retained in step 62, otherwise the source bus allocation is de-allocated in step 58. If one or more destinations are approved, then all edges on the path(s) are updated accumulating the streams REQ_DATA_UNIT value in step 60.

Where multiple destination allocations occur, it is possible that paths share the same edge. In this case the algorithm only increases an edge weight once because the packet will only be transmitted once. Therefore in step 60, each edge is only updated once per overall request.

After updating all edges participating in the path(s) the algorithm exits and permits the data source to begin transmission of the isochronous stream.

While the invention has been described with respect to a limited number of embodiments, it will be appreciated that many variations, modifications and other applications of the invention may be made.

In the method claims that follow, alphabetic characters used to designate claim steps are provided for convenience only and do not imply any particular order of performing the steps.

1. A method for allocating bandwidth and routing paths for isochronous packets of data streams in a network of buses interconnected by a switching fabric, comprising:
a) assigning a weight to each channel input output, CIO, based on existing path allocations;
b) selecting the optimal routing path for each data stream in dependence on the bandwidth requirements of the data stream and assigned weights;
c) assigning a channel number for each stream; and,
d) updating routing tables in the selected optimal path for the channel number to enable the data stream flow along the path.

2. A method according to claim 1, further comprising:
ai) defining a channel isochronous load, ISL, for each CIO, the ISL comprising a predetermined maximum percentage of channel capacity; and
aii) making available the remainder channel capacity to asynchronous communication.

3. A method according to claim 2, in which the step of selecting the optimal routing path comprises rejection of paths that include a CIO whose weight incremented by the bandwidth requirements of the stream exceeds the CIO's ISL.

4. A method for allocating bandwidth and routing paths for isochronous packets of a data stream in a network of buses including a source bus and one or more remote destination buses interconnected by a switching fabric, comprising:
i) assigning a network management node in the network on initialisation;
ii) assigning a weight to each channel input output, CIO, based on existing path allocations;
iii) obtaining bandwidth allocation for the isochronous packets in the source bus;
iv) requesting bandwidth and routing path allocation from the network management node for the isochronous packets to the remote destination buses, the network management node:
a) obtaining bandwidth allocation for the isochronous packets on the remote destination bus and selecting the optimal routing path in the switching fabric in dependence on the bandwidth requirements of the data stream and assigned weights;
b) assigning a channel number for the stream; and,
c) updating routing tables in the switching fabric of the selected optimal path for with routing commands indexed by the channel number to enable the data stream flow along the path.

5. A method according to claim 4, further comprising:
ia) defining a channel isochronous load, ISL, for each CIO, the ISL comprising a predetermined maximum percentage of channel capacity; and
iia) making available the remainder channel capacity to asynchronous communication.

6. A method according to claim 5, in which the step of selecting the optimal routing path comprises rejection of paths that include a CIO whose weight incremented by the bandwidth requirements of the stream exceeds the CIO's ISL.

7. A method according to claim 6, in which the bandwidth requirements of a stream comprise:
$$\frac{( \text{Requested data size} \times 4 )}{\text{Transmission speed index between source and destination}}$$

8. A method according to claim 7, in which the weight of a CIO comprises the sum of the bandwidth requirements of isochronous data streams currently allocated to use the CIO.

9. A method according to claim 6, further comprising:
v) if all paths to all remote destination buses are rejected determining if data stream transmission at the source is required and deallocating the allocation at the source bus if it is not required.

10. A method according to claim 4, further comprising:
vi) incrementing the weight of each CIO in the paths allocated to the data stream by the data stream's bandwidth requirements.

11. A computer readable medium, on which is stored a computer program of instructions for controlling a general purpose computer to for allocate bandwidth and routing paths for isochronous packets of data streams in a network of buses interconnected by a switching fabric, comprising, in combination:
means for assigning a weight to each channel input output, CIO, based on existing path allocations;
means for selecting the optimal routing path for each data stream in dependent on the bandwidth requirements of the data stream and assigned weights;
means for assigning a channel number for each stream; and,
means for updating routing tables in the selected optimal path for the channel number to enable the data stream flow along the path.

12. A computer readable medium according to claim 11, further comprising:
means for defining a channel isochronous load, ISL, for each CIO, the ISL comprising a predetermined maximum percentage of channel capacity; and
means for making available the remainder channel capacity to asynchronous communication.

13. A computer readable medium according to claim 11, in which the means for selecting the optimal routing path includes means for rejecting paths that include a CIO whose weight incremented by the bandwidth requirements of the stream exceeds the CIO's ISL.

14. A computer readable medium, on which is stored a computer program of instructions for controlling a general purpose computer to allocate bandwidth and routing paths for isochronous packets of data streams in a network of buses interconnected by a switching fabric, comprising, in combination:
means for assigning a network management node in the network on initialisation;
means for assigning a weight to each channel input output, CIO, based on existing path allocations;
means for obtaining bandwidth allocation for the isochronous packets in the source bus;
means for requesting bandwidth and routing path allocation from the network management node for the isochronous packets to the remote destination buses, the network management node including, in combination:
means for obtaining bandwidth allocation for the isochronous packets on the remote destination bus and selecting the optimal routing path in the switching fabric in dependence on the bandwidth requirements of the data stream and assigned weights;
means for assigning a channel number for the stream; and,
means for updating routing tables in the switching fabric of the selected optimal path for with routing commands indexed by the channel number to enable the data stream flow along the path.

15. A computer readable medium according to claim 14, further comprising:
means for defining a channel isochronous load, ISL, for each CIO, the ISL comprising a predetermined maximum percentage of channel capacity; and
means for making available the remainder channel capacity to asynchronous communication.

16. A computer readable medium according to claim 15, in which the means for selecting the optimal routing path comprises means for rejecting paths that include a CIO whose weight incremented by the bandwidth requirements of the stream exceeds the CIO's ISL.

17. A computer readable medium according to claim 16, further comprising means for determining the bandwidth requirements of a stream by executing the formula:
$$\frac{( \text{Requested data size} \times 4 )}{\text{Transmission speed index between source and destination}}$$

18. A computer readable medium according to claim 17, further comprising means for calculating the weight of a CIO from the sum of the bandwidth requirements of isochronous data streams currently allocated to use the CIO.

19. A computer readable medium according to claim 16, further comprising means for determining if all paths to all remote destination buses are rejected, means for determining if data stream transmission at the source is required and means for deallocating the location at the source bus if it is not required.

20. A computer readable medium according to claim 14, further comprising means for incrementing the weight of each CIO in the paths allocated to the data stream by the data stream's bandwidth requirements.

21. A program storage device readable by a machine and encoding a program of instructions for executing the method steps of claim 1.

22. A program storage device readable by a machine and encoding a program of instructions for executing the method steps of claim 4.

23. A data communication network arranged for optimal allocation of bandwidth and routing paths for isochronous packets of a data stream, the network comprising:
a plurality of buses including a source bus and one or more remote destination buses, each bus having an isochronous resource manager responsible for bandwidth allocation to isochronous streams on it respective bus;
a switching fabric interconnecting the plurality of buses; and,
a network management node;
wherein each channel input output, CIO, in the network has an assigned weight value based on existing path allocations, and wherein upon receiving a request for bandwidth allocation for isochronous packets from a source on its own bus, the source bus being arranged to reserve bandwidth in its bus and requesting bandwidth and routing path allocation from the network management node for the isochronous packets to the remote destination buses, the network management node communicating with the isochronous resource manager of each destination bus to obtain bandwidth allocation for the isochronous packets on the remote destination bus, selecting the optimal routing path in the switching fabric in dependence on the bandwidth requirements of the data stream and assigned weights, assigning a channel number for the stream, and updating routing tables in one or more memories throughout the switching fabric of the selected optimal path for with routing commands indexed by the channel number to enable the data stream flow along the path.
